(19) United States
(12) Patent Application Publication
(10) Pub. No.: US 2024/0239680 A1
(43) Pub. Date: Jul. 18, 2024

(54) BINARY METAL HYDROXIDE NITRATE

(71) Applicants: TIB Chemicals AG, Mannheim (DE); ZF Airbag Germany GmbH, Aschau am Inn (DE)

(72) Inventors: Michael König, Waldkraiburg (DE); Matthias Weiß, Altlussheim (DE); Sebastian Schäfer, Mannheim (DE)

(21) Appl. No.: 18/561,866

(22) PCT Filed: May 18, 2021
(86) PCT No.: PCT/EP2021/063198

§ 371 Date: Nov. 17, 2023

(51) Int. Cl. C01G 9/00; C06D 5/00

(52) U.S. Cl. CPC C01G 9/006; C06D 5/00; C01P 2002/72; C01P 2002/85; C01P 2002/88; C01P 2004/03; C01P 2004/82

(57) ABSTRACT

A binary phase-pure copper/zinc hydroxide nitrate of the formula (Ia),

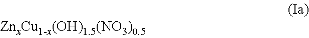

wherein the relationship 0.3<x≤0.5 applies to the variable x,
and a method for the preparation thereof are provided.

Copper/zinc hydroxide nitrates according to the invention are particularly suitable for use as oxidizing agent in a gas-generating composition for a gas generator, particularly for a safety device, especially for a safety device in a vehicle.

### TECHNICAL FIELD

The invention relates to metal hydroxide nitrates (basic metal nitrates) of copper and zinc, to a method for the preparation thereof and to the use of metal hydroxide nitrates of copper and zinc as oxidizing agent in a gas-generating composition, in particular for a safety device in a vehicle. The invention further relates to the use of such a gas-generating composition in a gas generator and a safety device.

### BACKGROUND

Metal hydroxide nitrates of the general composition

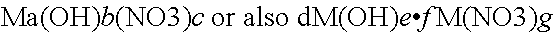

have long been described for a large number of metals of the main and especially transition groups of the Periodic Table of the Elements. They exist in a variety of structure types—some as hydrates, others as anhydrous salts.

Metal hydroxide nitrates in which several types of metal play a role have also been described in the patent and scientific literature.

Koy et al. in WO 03/053575 describe the preparation of catalysts for methanol synthesis, in which precipitation products of different metals play a role as intermediates. The synthetic route described therein shows that metal nitrate solutions of copper and zinc can also be used as starting materials. However, the resulting precipitation products are subsequently subjected to thermal treatment with the aim of having different metal oxides available side by side on a likewise oxidic carrier material.

Muhamad et al. in Catal. Today 131 (2008) 118 report the synthesis of a basic copper/zinc nitrate in an ammoniacal environment. Specifically described is a copper/zinc hydroxide nitrate ZnxCu1-x(OH)1.5(NO3)0.5 where x=0.3. In the X-ray powder diffractogram of the isolated material, the group identified reflections of the structure of basic copper nitrate (Gerhardite structure) in addition to a series of further peaks which the authors could not assign. Nevertheless, a monophasic character of the material obtained was postulated.

Sengupta et al. in Appl. Catal. 55 (1989) 165 report that, as a first step in the preparation of copper/zinc mixed oxide catalysts, the basic salts of the metals are precipitated from the mixed nitrate solutions by addition of ammonium hydroxide. According to the article, a monophasic co-precipitate was obtained and characterized by various physical methods, which is evidently an ammonia adduct.

Markov et al. in Mater. Chem. Phys. 26 (1990) 493 report the thermal decomposition of copper/zinc hydroxide nitrate with the aim of obtaining catalytically active metal oxide mixtures. Specifically described are copper/zinc hydroxide nitrates ZnxCu1-x(OH)1.5(NO3)0.5 where x=0.3 and 0.7. The synthetic route described for the copper/zinc hydroxide nitrates allows the reaction to proceed at boiling point.

Mannoorettonnil et al. in Bull. Soc. Chim. Bel. 84 (1975) 179 disclose basic copper/zinc nitrates and chlorides obtained by precipitation from dissolved mixtures of copper and zinc nitrate by means of aqueous sodium hydroxide solution. When analyzing the precipitates, a monophasic system is found up to a 25% molar content of zinc, but several phases were observed at higher zinc contents.

Atanasov et al. in J. Solid State Chem. 118 (1995) 303 describe a basic copper/zinc nitrate hydrate (ZnxCu1-x)(OH)2-y(NO3H)y·z H2O. The authors restrict the possibility of synthesizing a phase-pure material to the stoichiometry range 0<x<0.3.

In contrast to these results, it has now been found, surprisingly, that even copper/zinc hydroxide nitrates of the general formula (I),

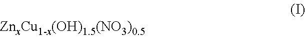

where the relationship 0<x<1 applies to the variable x,
may be prepared phase-pure with a higher proportion of zinc.

Furthermore, it has been found that metal hydroxide nitrates of copper and zinc are outstandingly suited for use as oxidizing agents in a gas-generating composition for a safety device, in particular for a safety device in a vehicle.

In addition to the fuels they contain, gas-generating compositions generally require additional oxidizing agents, for example to achieve a substantially equalized oxygen balance.

An equalized oxygen balance is advantageous, for example, for the use of airbag modules in the interior of a vehicle. In this case, increased requirements apply to the propellant gas generated, as this may, for example, enter the passenger compartment via outlet openings in the airbag and thus reach the vehicle occupants. The limit values for gas components such as CO, NH3 and NOx required by the specifications of the car manufacturers can generally only be achieved by fuel mixtures with a substantially equalized oxygen balance.

Common oxidizing agents are in particular basic metal nitrates, such as those described for example in Aguirre et al.: “Simple Route for the Synthesis of Copper Hydroxy Salts” (J. Braz. Chem. Soc., 22 (3), 2011, p. 546-551).

Katsuda et al. in U.S. Pat. No. 6,854,395 report an application for basic metal nitrates in propellants for pyrotechnic airbags, in which one or more representatives of this substance class are used. However, these are in all cases subsequently produced mixtures of metal hydroxide nitrates Ma(OH)b(NO3)c, which had previously been prepared separately.

Hinshaw et al. refer to the same application, who list in U.S. Pat. No. 5,725,699 a basic metal hydroxide nitrate that comprises cobalt in addition to copper. However, there are no references to the synthetic route or analytical data. Metal hydroxide nitrates of copper and zinc are not described in this document.

### SUMMARY

The invention therefore relates firstly to binary phase-pure copper/zinc hydroxide nitrates of the formula (Ia),

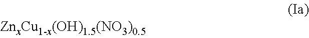

wherein
the relationship 0.3<x≤0.5 applies to the variable x.

The invention further relates to a method for preparing the copper/zinc hydroxide nitrates (Ia) according to the invention in a one-pot reaction, in which zinc nitrate is initially charged in an aqueous medium and an aqueous solution of copper(II) nitrate and an aqueous solution of an alkali metal hydroxide or alkaline earth metal hydroxide are added thereto simultaneously but separately, characterized in that substantially stoichiometric amounts of copper(II) nitrate and zinc nitrate are used, according to the desired value of x, and that the reaction proceeds at a temperature in the range of 20-70° C.

The invention also relates to a binary phase-pure copper/zinc hydroxide nitrate of the formula (Ia),

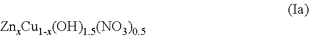

wherein
the relationship 0.3<x≤0.5 applies to the variable x,
obtainable by a method in which zinc nitrate is initially charged in an aqueous medium and an aqueous solution of copper(II) nitrate and an aqueous solution of an alkali metal hydroxide or alkaline earth metal hydroxide are added thereto simultaneously, but separately, in a one-pot reaction, characterized in that substantially stoichiometric amounts of copper(II) nitrate and zinc nitrate are used, according to the desired value of x, and that the reaction proceeds at a temperature in the range of 20-70° C.

The invention further relates to the use of copper/zinc hydroxide nitrates, preferably copper/zinc hydroxide nitrates of the formula (Ia), as oxidizing agent in a gas-generating composition for a safety device, in particular for a safety device in a vehicle.

The invention also relates to a safety device, in particular a safety device for use in a vehicle, comprising a gas generator comprising a gas-generating composition which comprises one or more copper/zinc hydroxide nitrates, preferably one or more copper/zinc hydroxide nitrates of the formula (Ia), as oxidizing agent.

By using copper/zinc hydroxide nitrates according to the invention as oxidizing agent, gas-generating compositions can be provided which, inter alia, have a substantially equalized oxygen balance and allow good control of the ballistic behavior and the combustion properties, for example, when setting a combustion temperature, the combustion rate and/or slag formation during decomposition of the gas-generating composition. They are therefore particularly suitable for use in a gas-generating composition for a safety device, in particular for a safety device in a vehicle.

The use of copper/zinc hydroxide nitrates according to the invention also makes it possible to suppress a light phenomenon occurring in the reaction of the gas-generating composition, which is also referred to as “flaming”. By using zinc as a further element in the basic mixed metal nitrate, zinc oxide is formed during decomposition of the gas-generating composition, which is at least partially doped with copper as the further metal of the basic mixed metal nitrate. Zinc oxide is a semiconductor with a band gap that enables the absorption of ultraviolet and visible light. Copper doping can minimize the size of the band gap, which shifts the emission that occurs after absorption into the range of infrared light. This applies especially in the case of the high temperatures occurring during decomposition of the gas-generating composition, which can also cause a reduction in the band gap, which is further enhanced by further doping. By shifting the light emission into the range of infrared light, a reduction of the light emission visible to humans during decomposition of the gas-generating composition can therefore be achieved. Activation of the safety device is therefore less noticeable to a user or vehicle occupants.

The copper/zinc hydroxide nitrates of the formula (Ia) according to the invention are binary, i.e. they comprise no other metals in addition to copper and zinc, and are phase-pure.

In the context of the invention, “phase-pure” signifies that a radiographically monophasic reaction product is obtained, which is in particular free of the boundary phases of the copper-zinc system and does not comprise any oxides or hydroxides of the metals copper and zinc as by-products.

Furthermore, the copper/zinc hydroxide nitrates of the formula (Ia) according to the invention do not comprise any further nitrogen-containing chelating agents such as NH3 and no water of crystallization. The copper/zinc hydroxide nitrates of the formula (Ia) according to the invention preferably do not comprise any further chelating agents or other components, i.e. the copper/zinc hydroxide nitrates of the formula (Ia) according to the invention consist of the composition of formula (Ia).

The variable x is preferably 0.31≤x, particularly preferably 0.35≤x, especially preferably 0.4≤x. Furthermore, x is preferably 0.4, 0.45 or 0.5, especially 0.5. In the latter case, the copper/zinc hydroxide nitrate (Ia) according to the invention corresponds to the formula ZnCu(OH)3NO3. This corresponds to a zinc incorporation rate of 50%, the highest that can be produced as monophasic copper/zinc hydroxide nitrate. In a further embodiment, the following applies to the variable x: x<0.5, especially x≤0.49.

In accordance with the invention, the phase-pure binary copper/zinc hydroxide nitrates of the formula (Ia) are preferably obtained by a one-pot reaction in which zinc nitrate is initially charged in an aqueous medium and an aqueous solution of copper(II) nitrate and an aqueous solution of an alkali metal hydroxide or alkaline earth metal hydroxide are added thereto simultaneously, but separately, characterized in that substantially stoichiometric amounts of copper(II) nitrate and zinc nitrate are used, according to the desired value of x, and that the reaction proceeds at a temperature in the range of 20-70° C.

Substantially stoichiometric amounts generally signifies a molar ratio of copper nitrate to zinc nitrate in the range of 1.3-0.7, preferably 1.2-0.8, particularly preferably 1.1-0.9, based in each case on the desired value of x.

The concentration of the zinc nitrate initially charged is generally in the range of 0.5-4.2, preferably 2-4.2, particularly preferably 3-4.1, mol/1.

The concentration of the copper nitrate solution is generally in the range of 0.5-3.8, preferably 2-3.8, particularly preferably 3-3.7, mol/1.

An alkali metal hydroxide is preferably used as the hydroxide, particularly preferably sodium hydroxide.

The stoichiometric ratio of hydroxide to metal nitrates used is generally in the range of 1.1-1.5, preferably 1.3-1.5, especially preferably 1.4-1.5.

The concentration of the hydroxide solution, preferably sodium hydroxide solution, is generally in the range of 1-6, preferably 2-6, especially preferably 3-6, mol/1.

The method according to the invention is carried out at a temperature in the range of 20-70° C., preferably 40-65° C., particularly preferably 55-65° C., especially 60° C.

The feed rate for the copper nitrate solution and hydroxide solution is preferably substantially the same and is generally in the range of 3-50, preferably 4-25, especially preferably 6-10, ml/min.

The synthesis according to the invention is further characterized in that said synthesis does not require the use of additional chelating agents; in a preferred embodiment of the method, therefore, no further chelating agents, in particular no urea or NH3 or substances releasing NH3 in the course of the reaction, are added in addition to the feedstocks specified.

The method according to the invention is thus carried out by precipitation, starting from the corresponding metal nitrate solutions, which is caused by a specific increase in the pH of the reaction mixture. After completion of the precipitation, recognizable by a sudden increase in pH to about 7, the solid reaction product can be separated from the mother liquor for work-up, washed with water and dried.

The method according to the invention is characterized, inter alia, in that a low residual content of metal cations in the mother liquor is ensured after completion of the precipitation of the target product and work-up thereof. This is of particular economic importance with regard to the treatment of production wastewater.

The success of the synthesis is verified analytically. A chemical analysis of the composition of the processed synthetic product serves to confirm that it comprises the metals previously incorporated with the starting materials.

An X-ray powder diffractometric analysis of the reaction product can provide information as to whether the copper/zinc hydroxide nitrate (Ia) according to the invention has been formed and whether it is phase-pure or mixed with by-products. If X-ray powder diffractometric phase purity and crystallinity have been demonstrated for the reaction product and the presence of both metals used has been chemically confirmed, it can be concluded that the copper/zinc hydroxide nitrate of the formula (Ia) according to the invention has been formed.

This conclusion is particularly reliable if a comparison of the measured reflection positions of the copper/zinc hydroxide nitrate of the formula (Ia) according to the invention with reflection positions of the structurally identical boundary phase copper hydroxide nitrate known from the literature shows a systematic shift along the 2-theta scale. Such positional shifts of identically indexable reflections in the X-ray powder diffractogram are a sure sign of the topotactic exchange of a proportion x of the copper in the cation sub-lattice by zinc. The larger x is, the clearer the shift in reflection positions.

In addition, the success of the synthesis is demonstrated by thermogravimetry. If the processed reaction product decomposes in a single step along the temperature scale, phase purity can be concluded. This finding then also confirms the absence of any X-ray amorphous by-products that would not be visible in the X-ray powder diffractogram.

SEM/EDX (Scanning Electron Microscopy with Energy Dispersive X-ray Spectroscopy) is another way of ascertaining the chemical composition of the material and its phase purity. If no sample constituents having very different metal ratios are identified and no components comprising only one of the two metals are detected, phase purity and the absence of X-ray amorphous constituents can be reliably assumed.

In particular, the synthesis is unsuccessful if, according to chemical analysis, the processed reaction product comprises only one of the two metals or if oxides or hydroxides of one or both of the metals used can be detected in the reaction product by X-ray powder diffractometry. The same applies if the presence of the boundary phases of the copper-zinc material system is confirmed in this way. It should be noted here that, depending on their crystallinity, foreign phases can only be detected in the material in this way from a median single-digit percentage. Synthesis experiments with a zinc supply higher than required for the maximum achievable incorporation rate inevitably result in the formation of foreign phases such as zinc oxide in addition to CuZn(OH)3NO3 (x=0.5). If the excess zinc, which is then not incorporated topotactically, corresponds to the intended incorporation rates in the range 0.5<x<0.6, it may be too low for the resulting foreign phases to be reliably detected. This is especially true if the foreign phases are X-ray amorphous.

Copper/zinc hydroxide nitrates, preferably copper/zinc hydroxide nitrates of the formula (I), are particularly suitable for use as oxidizing agents in a gas-generating composition for a safety device, in particular for a safety device in a vehicle.

Particularly preferred according to the invention are binary copper/zinc hydroxide nitrates of the formula (Ib),

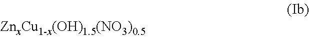

wherein
the relationship 0.05, preferably 0.1, particularly preferably 0.3<x≤0.6, preferably 0.55, particularly preferably 0.5, applies to the variable x and
wherein the material is preferably phase-pure in the range 0.05<x≤0.5.

Although copper/zinc hydroxide nitrates of the formula (Ib) with a value of x>0.5 that are used according to the invention are not phase-pure, in the case of a Zn content of such a non-phase-pure material, which is only slightly increased compared to that of a phase-pure material (preferably at x≤0.6, particularly preferably ≤0.55), the use according to the invention is largely unimpaired.

Binary phase-pure copper/zinc hydroxide nitrates of the formula (Ib) used according to the invention can preferably be obtained by the method described above.

Very particular preference is given to using the binary phase-pure copper/zinc hydroxide nitrates of the formula (Ia) according to the invention,

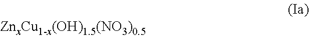

wherein
the relationship 0.3<x≤0.5 applies to the variable x.

The invention also relates to a gas-generating composition, in particular for a safety device, preferably for a safety device for use in a vehicle, comprising one or more copper/zinc hydroxide nitrates, preferably copper/zinc hydroxide nitrates of the formula (I), particularly preferably one or more copper/zinc hydroxide nitrates of the formula (Ib), especially preferably one or more copper/zinc hydroxide nitrates of the formula (Ia), as oxidizing agent.

The gas-generating composition used according to the invention may comprise as fuel all fuels known in the prior art and suitable for safety devices. For example, the fuel may be selected from the group consisting of boron, aluminum, silicon, magnesium, iron, titanium, tungsten, copper, carbon, zirconium, alloys of the elements cited above, nitrotriazolone, nitrocellulose, guanidine compounds, in particular nitroguanidine, salts and double salts of guanidine and guanidine compounds, in particular guanidinium nitrate, tetrazoles, aminotetrazoles, dinitramides and/or combinations of the aforementioned fuels.

The fuel is generally present in the gas-generating composition at a proportion of 5 to 95 percent by weight, preferably at a proportion of 10 to 90 percent by weight, particularly preferably 20 to 80 percent by weight, especially preferably at a proportion of 35 to 65 percent by weight.

In addition to the basic mixed metal nitrate, the gas-generating composition may comprise at least one further oxidizing agent, which is preferably selected from the group consisting of nitrates, oxides and/or mixed oxides of the alkali metals, alkaline earth metals and transition metals, transition metal nitrate hydroxides, chlorates, perchlorates, ammonium nitrate, sulfates, phosphates, oxalates, dinitramides, peroxides, water, oxygen and/or combinations thereof. In principle, all allotropes and all isotropes of the corresponding compounds are also included.

The gas-generating composition preferably comprises 10 to 60% by weight of one or more copper/zinc hydroxide nitrates used according to the invention, preferably one or more copper/zinc hydroxide nitrates of the formula (I), particularly preferably one or more copper/zinc hydroxide nitrates of formula (Ib), especially preferably one or more copper/zinc hydroxide nitrates of the formula (Ia), and optionally at least one further oxidizing agent.

The proportion of basic mixed metal nitrate and optionally of the at least one further oxidizing agent in the gas-generating composition is selected in particular in such a way that an equalized oxygen balance is achieved.

The gas-generating composition may additionally comprise 5% by weight or less of a processing aid, in particular 1 to 5% by weight, based on the total weight of the gas-generating composition. Processing aids are, for example, pressing aids, flow aids and/or lubricants, which do not significantly affect the combustion rate of the composition at the specified amount.

Examples of suitable processing aids are polyethylene glycol, cellulose, methyl cellulose, graphite, wax, metal soaps, such as calcium stearate, magnesium stearate, zinc stearate and/or aluminum stearate, boron nitride, talc, bentonite, silica and molybdenum sulphide and mixtures thereof.

In addition, the gas-generating composition according to the invention may comprise conventional combustion moderators and/or coolants, for example 10% by weight or less, in particular up to 6% by weight or 0.1 to 6% by weight, based on the total weight of the gas-generating composition. The additives specified have a stabilizing effect on the combustion and keep the combustion temperature low. At the same time, slagging of the combustion residues is improved, which prevents clogging of the residues.

Examples of suitable combustion moderators and/or coolants are B2O3, Al2O3, MgO, TiO2, SiO2, Mg(OH)2, basic magnesium carbonate, CaCO3 and mixtures thereof.

Furthermore, the gas-generating composition may additionally comprise 5% by weight or less of a further additive, in particular 0.1 to 5% by weight, based on the total weight of the gas-generating composition. The other additives serve in particular to improve the flammability and the mechanical properties of the gas-generating composition.

The combustion temperature of the gas-generating composition is preferably in a range of 1700K to 2300K.

The invention further relates also to a gas generator, preferably a gas generator for a safety device, in particular for a safety device for use in a vehicle, and to a safety device, in particular a safety device for use in a vehicle, wherein the gas generator or safety device each comprise a gas-generating composition, which comprises one or more copper/zinc hydroxide nitrates, preferably one or more copper/zinc hydroxide nitrates of the formula (I), particularly preferably one or more copper/zinc hydroxide nitrates of the formula (Ib), especially preferably one or more copper/zinc hydroxide nitrates of the formula (Ia), as oxidizing agent.

The invention also relates to the use of the gas-generating composition according to the invention in a gas generator, preferably in a gas generator for a safety device, in particular for a safety device for use in a vehicle, and in a safety device, in particular in a safety device for use in a vehicle.

The safety device is arranged, for example, in a vehicle, a safety vest or a protector of a user.

The invention is elucidated by the following examples, without being intended to be limited thereto.

### EXAMPLES

### Synthesis Examples

### Synthesis Example 1

Preparation of a Binary Metal Hydroxide Nitrate CuZn(OH)3NO3 (x=0.5) According to the Invention

The synthesis was carried out in a glass reactor (volume 3 l) with heating jacket and propeller stirrer. The temperature was controlled with a thermostat, the pH was controlled with a pH meter (Portavo 907 Multi pH, from Knick).

A solution of zinc nitrate (Zn(NO3)2, 17.1% Zn, density 1.60 kg/l, 765 g) was temperature-controlled at 60° C. and stirred at 400 rpm. The solution had a pH close to 0.

To this initial charge were added simultaneously a solution of copper nitrate (Cu(NO3)2), 15.6% Cu, density 1.54 kg/l, 782 g, metered addition rate 5 ml/min) and aqueous sodium hydroxide solution (NaOH, 20%, 1218 g, metered addition rate 10.5 ml/min) by means of membrane pumps (Simdos 10 FEM, from KNF). The addition continued until the pH jumped from 5-5.5 to ca. 7. This was the case after 103 minutes.

The product suspension was then filtered through a Buchner funnel with filter paper (pore size 7 μm) under an applied vacuum and washed with deionized water (4 l). The isolated filter cake was dried under vacuum at 65° C. to constant weight.

| | | | | | | | Cu | Zn |
|---|---|---|---|---|---|---|---|---|
| | | | | | Cu content | Zn content | content | content |
| | | | Yield with | Yield with | in mother | in mother | in the | in the |
| | Cu | Zn | respect to | respect to | liquor | liquor | eluate | eluate |
| Dry weight | content | content | Cu | Zn | [mg/l] | [mg/l] | [mg/l] | [mg/l] |
| 448 g | 27.0% | 27.2% | 99% | 93% | 0.1 mg/l | 4.4 mg/l | 0.72 | 218 |

The analytical data allows the conclusion that both metals are present in the sample at approximately equal proportions.

### Synthesis Example 1a

### X-Ray Powder Diffraction Analysis

The basic metal nitrate prepared according to the invention from Synthesis Example 1 is analzyed by X-ray powder diffractometry for the presence of known metal oxides, hydroxides, nitrates and hydroxide nitrates and for the occurrence of reflections of unknown phases.

The diffractograms are recorded with a D2 phaser X-ray diffractometer from Bruker, equipped with a Cu X-ray tube (CuKα radiation, λ=1.5405 Å). The measurements are made in Bragg-Brentano geometry in reflection. The device operates in the range of 5-70°2θ in step scan mode with a step size of 0.016°2θ and a step duration of 1 s.

Other measurement and device parameters:
anode voltage: 30 kV
anode current 10 mA
Lynxeye XE-T detector
Soller slit (primary beam): 2.5°
apertures (primary): 1 mm
secondary Soller: 2.5°
detector slit (secondary beam): 8 mm

For sample preparation, ca. 0.5 g of the material is filled into a stainless steel sample carrier, covered with a glass plate and compacted by tapping on a hard surface.

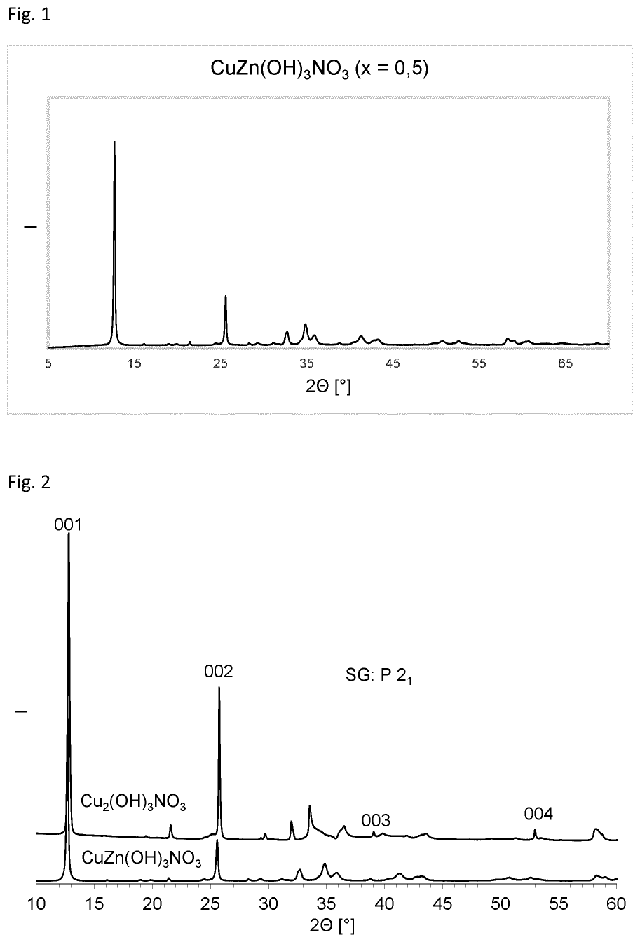

FIG. 1 shows the diffractogram of the binary copper/zinc hydroxide nitrate CuZn(OH)3NO3 (x=0.5) of the formula (Ia) from Synthesis Example 1.

The values of the diffraction angle 2θ are plotted in degrees on the X-axis, while the Y-axis represents the intensity I in dimensionless form.

FIG. 2 shows a comparison of the diffractograms of the material according to the invention from Synthesis Example 1 and of basic copper nitrate. The 26 values are plotted in degrees on the X-axis, while the Y-axis represents the intensity I in dimensionless form.

All essential reflections of the material according to the invention from Synthesis Example 1 can be assigned to the structure known for basic copper nitrate. There is no evidence for the presence of further crystalline phases.

The specification SG in FIG. 2 stands for the symmetry group. Both materials shown in FIG. 2 have the symmetry group P 21, i.e. the elementary cell is monoclinic.

Comparison with the material from Sengupta et al., Appl. Catal. 55 (1989) 175, FIG. 7:

A comparison of the XRD (X-ray diffraction spectrum) by Sengupta et al. shown in FIG. 7 with that of the basic copper/zinc nitrate according to the invention of Synthesis Example 1 shows that the materials are different.

The shift of the equivalent reflection positions in FIG. 7 of Sengupta et al. is precisely opposite to those of the basic copper/zinc nitrate according to the invention of Synthesis Example 1 in FIG. 1.

Only X-ray peaks of a hkl series one below another are to be considered. The difference between the two materials is significant.

This proves that the material in FIG. 7 of Sengupta et al. does not correspond to the CuZn(OH)3NO3 as indicated in the caption. Instead, it is likely to be an ammonia adduct. A complexing effect of ammonia on copper must be assumed under the synthesis conditions of Sengupta et al.

The XRD in FIG. 7 published in the cited publication also differs in a further point from that of the basic copper/zinc nitrate according to the invention of Synthesis Example 1. All peaks of the XRD in the literature citation show significantly larger full widths at half maximum.

In the range 32-37° 20, the XRD of the basic copper/zinc nitrate according to the invention of Synthesis Example 1 (FIG. 1) shows three peaks that are quite well resolved. This is not the case in the literature citation.

It can be concluded that the crystallinity of the entire literature sample is lower, presumably as a result of a second, X-ray amorphous phase. This is not identifiable in the XRD itself, but leads to the cited effects.

The metal contents according to Sengupta appear to have been determined only by the addition ratios of the nitrate solutions, a detailed analysis of the product not being described.

It also appears that the nitrate solutions were premixed before ammonium hydroxide was added. According to the results of the applicants, such a procedure does not result in binary metal hydroxide nitrates, at least not without the presence of chelating agents, which in turn influence the solubility/precipitability of the metal cations when the pH increases.

It is essential to note that Sengupta worked with ammonium hydroxide as a precipitating reagent. In combination with copper, this is primarily a complexing agent and only secondarily an alkali to increase the pH. Ammonium hydroxide is therefore not simply an alternative base to NaOH.

### Synthesis Example 1b

### Thermogravimetric Analysis

The thermogravimetric analyses of the material according to the invention from Synthesis Example 1 are carried out with the TGA 701 device from Leco. 1-5 g of the sample to be tested is/are placed in the pure state in an aluminum oxide crucible and then subjected to the measurements. These are conducted in the temperature range from room temperature to 650° C. with a stepped heating ramp over 24 h.

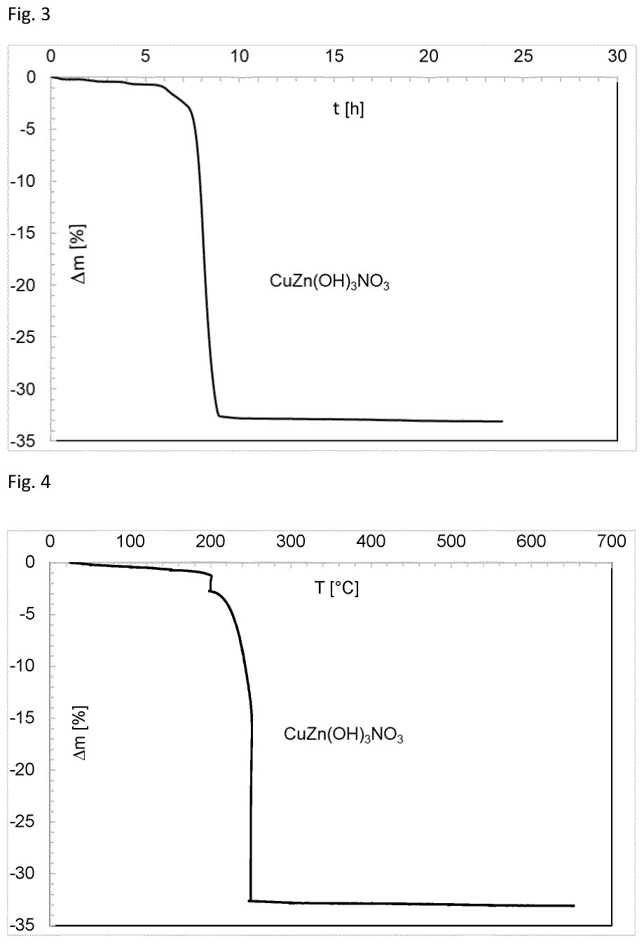

The diagram shown in FIG. 3 plots the mass loss Δm [%] during thermal decomposition against heating time t [h]. The diagram shown in FIG. 4 plots the same mass loss data Δm [%] against temperature T [° C.].

Thermal degradation takes place in a single step. This may be an indication of the pure-phase character of the sample.

Comparison with the material from Sengupta et al., Appl. Catal. 55 (1989) 177, FIG. 8:

FIG. 8 of the cited publication also shows that it does not contain the material which the authors mention.

Although the TG curve of the sample described as analogous to the basic copper/zinc nitrate according to the invention of Synthesis Example 1 is a one-step process, the thermal decomposition of the literature sample only begins at ca. 250° C. At this temperature, the thermal decomposition of the basic copper/zinc nitrate according to the invention of Synthesis Example 1 is already complete; it occurs between 180 and 230° C.

### Synthesis Example 1c

### Scanning Electron Microscopy Analysis

The scanning electron microscopy (SEM) analysis of the material from Synthesis Example 1 with energy dispersive X-ray spectroscopy (EDX) is carried out with a Stereoscan 360 type device from Cambridge. For this purpose, the sample is applied to a conductive tab, vapor-deposited with carbon and examined microscopically. The sample is tested for morphology and composition.

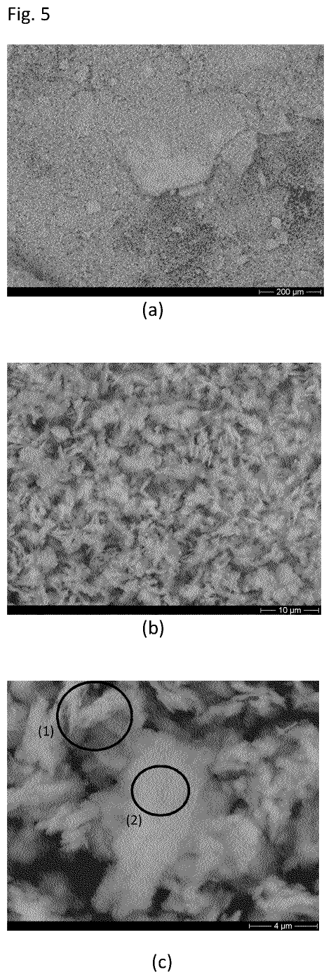

FIGS. 5a, 5b and 5c show the images of the SEM analysis of a sample at different magnifications. The length of the bar at the bottom right of the figure corresponds to an actual length of 200 μm (FIG. 5a), 10 μm (FIG. 5b) and 4 μm (FIG. 5c).

The composition determined by EDX at the two positions of the sample CuZn(OH)3NO3 (x=0.5) marked above in FIG. 5c is:

| | Needles | Aggregate |
|---|---|---|
| Cu | 51.6% | 47.0% |
| Zn | 48.4% | 53.0% |

Despite the differences detected in the metal contents, the SEM/EDX measurements show that the sample does not comprise any foreign phases with a composition fundamentally different from copper/zinc hydroxide nitrate. The aforementioned differences are of a metrological nature and are related to differences in the intensity of the detected signal depending on the locally varying sample qualities.

### Synthesis Example 2

### Preparation of a Binary Metal Hydroxide Nitrate According to the Invention

(Cu1-xZnx)2(OH)3NO3 where x=0.45

The synthesis was carried out in a glass reactor (volume 3 l) with heating jacket and propeller stirrer. The temperature was controlled with a thermostat, the pH was controlled with a pH meter (Portavo 907 Multi pH, from Knick).

820 g of a solution of zinc nitrate Zn(NO3)2 with 15.6% Zn (density 1.52 kg/l) were temperature-controlled at 60° C. and stirred at 400 rpm. The solution had a pH of 1. To this initial charge were added simultaneously 1033 g of a solution of copper nitrate (Cu(NO3)2) with 15.3% Cu (density 1.52 kg/l, metered addition rate 2.7 ml/min) and 2796 g of aqueous sodium hydroxide solution NaOH 9.8% (metered addition rate 10 ml/min) by means of membrane pumps (Simdos 10 FEM, from KNF). The addition continued until the pH jumped from 5-5.5 to 8.2. This was the case after 254 minutes. The product suspension was then filtered through a Buchner funnel with filter paper (pore size 7 μm) under an applied vacuum and washed with deionized water (3 l). The isolated filter cake was dried under vacuum at 65° C. to constant weight.

| | | | | | | | Cu | Zn |
|---|---|---|---|---|---|---|---|---|
| | | | | | Cu content | Zn content | content | content |
| | | | Yield with | Yield with | in mother | in mother | in the | in the |
| | Cu | Zn | respect to | respect to | liquor | liquor | eluate | eluate |
| Dry weight | content | content | Cu | Zn | [mg/l] | [mg/l] | [mg/l] | [mg/l] |
| 533 g | 29.6% | 23.5% | 100% | 98% | 0.32 | 0.20 | 0.41 | 81 |

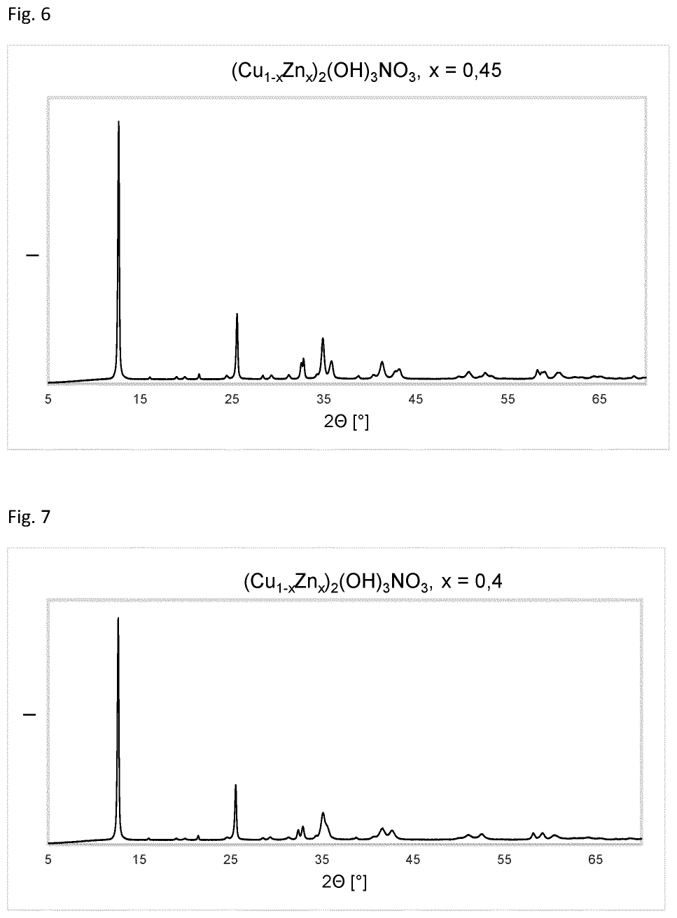

FIG. 6 shows the diffractogram (obtained analogously to Synthesis Example 1a) of the binary copper/zinc hydroxide nitrate (Cu1-xZnx)2(OH)3NO3 (x=0.45) of the formula (Ia) from Synthesis Example 2.

The values of the diffraction angle 2θ are plotted in degrees on the X-axis, while the Y-axis represents the intensity I in dimensionless form.

### Synthesis Example 3

### Preparation of a Binary Metal Hydroxide Nitrate According to the Invention

(Cu1-xZnx)2(OH)3NO3 where x=0.4

The synthesis was carried out in a glass reactor (volume 3 l) with heating jacket and propeller stirrer. The temperature was controlled with a thermostat, the pH was controlled with a pH meter (Portavo 907 Multi pH, from Knick).

755 g of a solution of zinc nitrate Zn(NO3)2 with 15.5% Zn (density 1.52 kg/l) were temperature-controlled at 60° C. and stirred at 400 rpm. The solution had a pH of 1. To this initial charge were added simultaneously 1158 g of a solution of copper nitrate Cu(NO3)2 with 15.2% Cu (density 1.52 kg/l, metered addition rate 6.1 ml/min) and 2858 g of aqueous sodium hydroxide solution NaOH 9.8% (metered addition rate 20 ml/min) by means of membrane pumps (Simdos 10 FEM, from KNF). The addition continued until the pH jumped from 5-5.5 to ca. 7-8.5. After 115 minutes, the metered addition rate of the copper nitrate solution was reduced to 5 ml/min, and after a total of 123 minutes to 3.5 ml/min. After 133 minutes, the pH increased to 8.5 and the addition was terminated. The product suspension was then filtered through a Buchner funnel with filter paper (pore size 7 μm) under an applied vacuum and washed with deionized water (3 l). The isolated filter cake was dried under vacuum at 65° C. to constant weight.

| | | | | | | | Cu | Zn |
|---|---|---|---|---|---|---|---|---|
| | | | | | Cu content | Zn content | content | content |
| | | | Yield with | Yield with | in mother | in mother | in the | in the |
| | Cu | Zn | respect to | respect to | liquor | liquor | eluate | eluate |
| Dry weight | content | content | Cu | Zn | [mg/l] | [mg/l] | [mg/l] | [mg/l] |
| 544 g | 32.4% | 21.1% | 100% | 98% | 0.29 | 1.10 | 1.24 | 161 |

FIG. 7 shows the diffractogram (obtained analogously to Synthesis Example 1a) of the binary copper/zinc hydroxide nitrate (Cu1-xZnx)2(OH)3NO3 (x=0.4) of the formula (Ia) from Synthesis Example 3.

The values of the diffraction angle 2θ are plotted in degrees on the X-axis, while the Y-axis represents the intensity I in dimensionless form.

### Application Examples

Examples of gas-generating compositions are given in Table 1.

TABLE 1
Gas-generating compositions according to the invention.

| Component | Substance | % by weight |
|---|---|---|
| Fuel | GuNi | 45 to 55 |
| Oxidizing agent | bCZN | 43 to 53 |
| Processing aid | Metal stearate | 0 to 3 |
| Coolant | Al2O3 | 0 to 3 |
| Combustion moderator | TiO2 | 0 to 3 |

The abbreviations used in Table 1 are:

GuNi=guanidinium nitrate

bCZN=basic copper/zinc nitrate (according to Synthesis Example 3)

The metal stearate used is a mixture of calcium stearate, magnesium stearate, zinc stearate.

The ballistic behavior was carried out using a series of tests on three compositions, as indicated in Table 2. For this purpose, the gas-generating compositions were compressed into cylindrical tablets having a diameter of 4 mm and a thickness of 1.3 mm.

The oxidizing agent used had a particle size d50 of 6 μm. The zinc content in the bCZN used according to Synthesis Example 2 was 22.9%.

Subsequently, 10 g of each tablet were weighed into a standard steel combustion chamber having a volume of 100 cm3, ignited by an igniter in the standard combustion chamber and the pressure curve inside the standard combustion chamber was monitored in order to determine the combustion rate of the respective tablet. The ballistic test was performed at a pressure of 10 MPa and 20 MPa. Each test was carried out twice and the obtained combustion rates were arithmetically averaged. It was shown that combustion rates measured with the compositions according to the invention for tablets of the size used and with oxidizing agents of the particle size used are in a range suitable for gas-generating compositions for use in safety devices.

TABLE 2
Composition for ballistic tests.

| | bCZN | GuNi | |
|---|---|---|---|
| [symbol] ample | (Oxidizing agent) | (Fuel) | Additives |
| | 45.9% by weight | 51.24% by weight | 2.86% by weight |
| | 48.5% by weight | 48.64% by weight | 2.86% by weight |
| | 47.41% by weight | 49.73% by weight | 2.86% by weight |

[symbol]

indicates data missing or illegible when filed

TABLE 3
Results of the ballistic tests of the examples from Table 2.

| | Combustion rate | Combustion rate |
|---|---|---|
| | at 10 MPa | at 20 MPa |
| Example | [mm/s] | [mm/s] |
| 1 | 15.2 | 19.2 |
| 2 | 15.2 | 19.4 |
| 3 | 14.8 | 18.8 |

If the bCZN in the gas-generating compositions according to the invention according to Table 1 is completely replaced by bCN (basic copper nitrate) having a particle size d50 of 1 μm, this results in combustion rates of 17.6 mm/s at 10 MPa and 22.25 mm/s at 20 MPa (comparative example 1).

If the bCZN in the gas-generating compositions according to the invention according to Table 1 is completely replaced by bCN, coated with one percent glycerol, having a particle size d50 of 1 μm, this results in combustion rates of 19.5 mm/s at 10 MPa and 24.3 mm/s at 20 MPa (comparative example 2).

1. A binary phase-pure copper/zinc hydroxide nitrate of the formula (Ia), 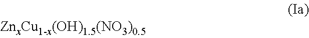
wherein
the relationship 0.3≤x≤0.5 applies to the variable x.

2. A binary phase-pure copper/zinc hydroxide nitrate of the formula (Ia), 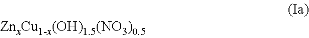
wherein
the relationship 0.3<x≤0.5 applies to the variable x,
obtainable by a method in which zinc nitrate is initially charged in an aqueous medium and an aqueous solution of copper(II) nitrate and an aqueous solution of an alkali metal hydroxide or alkaline earth metal hydroxide are added thereto simultaneously but separately in a one-pot reaction, characterized in that substantially stoichiometric amounts of copper(II) nitrate and zinc nitrate are used, according to the desired value of x, and that the reaction proceeds at a temperature in the range of 20-70° C.

3. The binary phase-pure copper/zinc hydroxide nitrate of the formula (Ia) as claimed in claim 1 or 2, characterized in that the relationship 0.31≤x, preferably 0.35≤x, particularly preferably 0.4≤x, applies to the variable x.

4. The binary phase-pure copper/zinc hydroxide nitrate of the formula (Ia) as claimed in any of claims 1 to 3, characterized in that the variable x is 0.4 or 0.5.

5. The binary phase-pure copper/zinc hydroxide nitrate of the formula (Ia) as claimed in any of claims 1 to 4, characterized in that it does not comprise any further nitrogen-containing chelating agents.

6. A method for preparing a binary phase-pure copper/zinc hydroxide nitrate of the formula (Ia) as claimed in any of claims 1 to 5, wherein zinc nitrate is initially charged in an aqueous medium and an aqueous solution of copper(II) nitrate and an aqueous solution of an alkali metal hydroxide or alkaline earth metal hydroxide are added thereto simultaneously but separately in a one-pot reaction, characterized in that substantially stoichiometric amounts of copper(II) nitrate and zinc nitrate are used, according to the desired value of x, and that the reaction proceeds at a temperature in the range of 20-70° C.

7. The method as claimed in claim 6, characterized in that the molar ratio of copper nitrate to zinc nitrate is in the range of 1.3-0.7, preferably 1.2-0.8, particularly preferably 1.1-0.9, based in each case on the desired value of x.

8. The method as claimed in claim 6 or 7, characterized in that the concentration of zinc nitrate initially charged is in the range of 0.5-4.2, preferably 2-4.2, particularly preferably 3-4.1, mol/1.

9. The method as claimed in any of claims 6 to 8, characterized in that the concentration of copper nitrate solution is in the range of 0.5-3.8, preferably 2-3.8, particularly preferably 3-3.7, mol/1.

10. The method as claimed in any of claims 6 to 9, characterized in that the hydroxide used is an alkali metal hydroxide, preferably sodium hydroxide.

11. The method as claimed in any of claims 6 to 10, characterized in that the stoichiometric ratio of hydroxide to metal nitrates used is in the range of 1.1-1.5, preferably 1.3-1.5, particularly preferably 1.4-1.5.

12. The method as claimed in any of claims 6 to 11, characterized in that the concentration of hydroxide solution is in the range of 1-6, preferably 2-6, particularly preferably 3-6, mol/1.

13. The method as claimed in any of claims 6 to 12, characterized in that said method is carried out at a temperature in the range of 20-70° C., preferably 40-65° C., particularly preferably 55-65° C., especially 60° C.

14. The method as claimed in any of claims 6 to 13, characterized in that the feed rate for copper nitrate solution and hydroxide solution is essentially the same and is in the range of 3-50, preferably 4-25, particularly preferably 6-10, ml/min.

15. The method as claimed in any of claims 6 to 14, characterized in that no further chelating agents, in particular no urea or NH₃ or substances releasing NH₃ in the course of the reaction, are added in addition to the feedstocks specified.

16. The use of copper/zinc hydroxide nitrates as oxidizing agent in a gas-generating composition for a gas generator, in particular for a safety device, in particular for a safety device in a vehicle.

17. The use as claimed in claim 16, characterized in that, as copper/zinc hydroxide nitrate, one or more binary and, for values of x≤0.5, phase-pure copper/zinc hydroxide nitrates of formula (Ib) are used 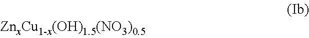
wherein the relationship 0.05≤x≤0.6, preferably 0.1≤x≤0.5, applies to the variable x.

18. The use as claimed in claim 16 or 17, characterized in that, as copper/zinc hydroxide nitrate, one or more binary phase-pure copper/zinc hydroxide nitrates of formula (Ia) are used 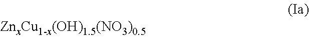
wherein the relationship 0.3<x≤0.5 applies to the variable x.

19. A gas-generating composition, particularly for a gas generator for a safety device, preferably for a safety device for use in a vehicle, comprising one or more copper/zinc hydroxide nitrates, preferably one or more copper/zinc hydroxide nitrates of the formula (Ib) as claimed in claim 17, particularly preferably one or more copper/zinc hydroxide nitrates of the formula (Ia) as claimed in claim 18, as oxidizing agent.

20. A gas generator, preferably for a safety device, particularly for a safety device for use in a vehicle, comprising a gas-generating composition comprising one or more copper/zinc hydroxide nitrates, preferably one or more copper/zinc hydroxide nitrates of the formula (Ib) as claimed in claim 17, particularly preferably one or more copper/zinc hydroxide nitrates of the formula (Ia) as claimed in claim 18, as oxidizing agent.

21. A safety device, particularly for use in a vehicle, comprising a gas generator comprising a gas-generating composition comprising one or more copper/zinc hydroxide nitrates, preferably one or more copper/zinc hydroxide nitrates of the formula (Ib) as claimed in claim 17, particularly preferably one or more copper/zinc hydroxide nitrates of the formula (Ia) as claimed in claim 18, as oxidizing agent.
